(19) United States
(12) Patent Application Publication
(10) Pub. No.: US 2009/0206243 A1
(43) Pub. Date: Aug. 20, 2009

(54) Image Capturing System and Method for the Analysis of Image Data

(75) Inventor: Juergen Eisen, Augsburg (DE)

Correspondence Address: FISH & RICHARDSON PC, P.O. BOX 1022, MINNEAPOLIS, MN, 55440-1022, US

(73) Assignee: Texmag GmbH Vertriebsgesellschaft, Thalwil (CH)

(21) Appl. No.: 12/367,341

(22) Filed: Feb. 6, 2009

Related U.S. Application Data
(60) Provisional application No. 61/041,304, filed on Apr. 1, 2008.
(60) Provisional application No. 61/041,319, filed on Apr. 1, 2008.

(30) Foreign Application Priority Data
Feb. 11, 2008 (EP) EP08151277.4
Feb. 11, 2008 (EP) EP08151278.2

(51) Int. Cl. G01J 1/42

(52) U.S. Cl. 250/227.11

(57) ABSTRACT

This application relates to image capturing systems and methods for the analysis of image data.

### CROSS-REFERENCE TO RELATED APPLICATIONS

This application claims priority under 35 U.S.C. § 119 to European Patent Application No. EP08151278.2, filed Feb. 11, 2008, the contents of which are hereby incorporated by reference in its entirety, and under 35 U.S.C. § 119 to U.S. Provisional Patent Application No. 61/041,304, filed on Apr. 1, 2008, the contents of which are hereby incorporated by reference in its entirety. This application also claims priority under 35 U.S.C. § 119 to European Patent Application No. EP08151277.4, filed Feb. 11, 2008, and under 35 U.S.C. § 119 to U.S. Provisional Patent Application No. 61/041,319, filed on Apr. 1, 2008.

### FIELD OF APPLICATION

This application relates to image capturing systems and methods for the analysis of image data.

### BACKGROUND

Image capturing systems and methods for the analysis of image data are used in systems for the manufacturing of material webs, such as printed paper sheets, foils or textile webs.

As shown in FIG. 1, a capturing system 110 may be used to detect an image 100 on a printed material web 101. The image is detected at a specific point in time during a scan. Images may be detected successively at different points in time during the scan, for example across the direction A of a material web in a traverse motion via a rail system 161 driven by a motor 160. The scan may occur in the direction A of the material, e.g. by moving the material web 101 in the material web direction A. The image data may be transmitted via a line 162 to a control and processing unit 163, where the image data are being processed. The results may be displayed for the user on an output terminal 164, such as a monitor. The display may be used to evaluate the print quality of the printed material web 101, for example. An input terminal 165—a keyboard, for example—may be used to send commands to the control and processing unit 163 and, in doing so, also to the capturing system 110. The control and processing unit 163 can also send commands to the motor 160.

Illumination conditions may play a very important role in capturing the image 100 of the material web 101. For example, in the case of mirrored or embossed material surfaces illumination with diffuse light may generally be needed. Image capturing systems may include illuminating elements that generate a flash, such as strobe lamps for example. For example, scatter disks or indirect illumination with white reflective surfaces may be used to achieve diffuse illumination.

### SUMMARY

This application relates to image capturing systems and methods for the analysis of image data.

According to one aspect, an image capturing system includes a capturing device located along a main axis for the capture of the image and an illuminating element to generate diffuse/scattered light. The illuminating element includes a light-guiding element and at least one light source, which is configured such that the light it emits is injected into the light-guiding element, where it propagates. The light-guiding element is designed such that the light propagating in the light-guiding element exits at least one surface area of the light-guiding element in a diffuse state.

In different embodiments, the light-guiding element may exhibit one or more of the following characteristics. The light-guiding element may include a flat plate. In this case, the light-guiding element may be configured such that the flat plate is located in a plane parallel to an object plane, i.e., a plane in which the image is located. The light-guiding element may be designed—for example, with the exception of the surface areas from where the emitted light is directed and the surface areas, in which the propagating light exits in a diffuse state—for the surface areas of the light-guiding element to exhibit a mirrored or a reflective coating. The surface areas, into which the emitted light is directed, may be smooth, for example, polished. The light-guiding element may be made of a material with scattered particles, so that the propagating light exits the at least one surface area in a diffuse state. The light-guiding element can be made of a transparent material, for example, acrylic glass. The light-guiding element can be designed such that the capturing device captures the image through the light-guiding element. Alternatively, the light-guiding element may be designed with a cutout located in an area, in which the capturing device captures the image. The light-guiding element may be located between the capturing device and the image. The light-guiding element may also be located on the side opposite the capturing device. The illuminating element may in particular include at least two light-guiding elements and at least one switching element for the selective blocking or unblocking of the light propagating in one of the light-guiding elements. In such case, the at least two light-guiding elements and the at least one switching element may alternate. The illuminating element may be designed for the at least two light-guiding elements to have a triangular shape. The at least two light-guiding elements and the at least one switching element may be configured around a central point, forming a closed area. The illuminating element may include at least a first and a second light source. The first and the second light source may be located on opposite sides of the light-guiding element. The first and the second light source can be light sources of different types. The system may include a control element for the selective on and off switching of the first or the second light source. Finally, the image may be located on a material web, and the at least one light source may be a gas-discharge lamp, for example, a flash tube.

Embodiments of the invention may provide any, all or none of the following advantages. The system may provide evenly distributed illumination during the capture of an image, and may thereby achieve a good image quality. Shadows during the capture of an image on a background plate like, for example, on shiny, highly transparent foil sheets, may be prevented due to the same direction of capture and illumination. In addition, the system may have a compact design, and may exhibit a low installation depth. The capturing device and the illuminating element may constitute a single unit, which may be easily installed and deployed. In addition, in some embodiments, the system may be used for many applications, e.g., without the development of individual and expensive illumination concepts for each individual application. The system may also easily be supplied in different sizes.

According to another aspect, a system for the capturing of images in an image plane includes a first sensor element and a first imaging element as well as at least one second sensor element and at least one second imaging element. The system can be used to capture a first capturing area and at least one second capturing area inside an image plane.

In different embodiments, the system or the method may have one or more of the following features. The sensor element and the imaging element may be configured such that the second capturing area is smaller than the first capturing area. The sensor element and the imaging element can be configured such that the second capturing area includes a partial section of the first capturing area. The sensor element and the imaging element may be configured such that the second capturing area is located inside the first capturing area. The first imaging element may include a first optical axis and the second imaging element may include a second optical axis. The first sensor element may be configured such that the center of the first sensor element is offset from the first optical axis. The first sensor element can be configured such that the center of the first sensor element is located on a line passing through the center of the first capturing area and the center of the first imaging element. The second sensor element may be centered in relation the second optical axis.

The first sensor element and the first imaging element may be configured such that the first capturing area will be mapped by the first imaging element and detected by the first sensor element. The second sensor element and the second imaging element may be configured such that the second capturing area will be mapped by the second imaging element and detected by the second sensor element. The second sensor element may be configured such that the center of the second sensor element is offset from the second optical axis. The second sensor element may be configured such that the center of the second sensor element is located on a line passing through the center of the second capturing area and the center of the second imaging element. The first sensor element may be centered in relation to the first optical axis. The first sensor element and the first imaging element may be configured such that the second capturing area is mapped by the first imaging element and detected by the first sensor element. The second sensor element and the second imaging element may be configured such that the first capturing area is mapped by the second imaging element and detected by the second sensor element. The first optical axis and the second optical axis may be parallel to each other. The first sensor element can be configured in a plane parallel to the image plane. The second sensor element can be configured in a plane parallel to the image plane. The first imaging element and the second imaging element may have different focal lengths. The first imaging element may have a shorter focal length than the second imaging element. The system may be designed such that the second sensor element captures a larger image (a smaller image section) in comparison to the first sensor element. The image may be located on a material web. The first and/or the second imaging element may include a lens component. The first and/or the second imaging element may be a fixed lens. The first and/or the second sensor element may be a CMOS chip.

According to one aspect, a method for the analysis of image data includes a first capturing device and at least one second capturing device for the capturing of an image within an image plane. The method furthermore includes the capture of a first capturing area to obtain a first set of image data and the capture of at least one second capturing area to obtain a second set of image data. Finally, the method includes the evaluation of the first and/or the second image data.

In various embodiments, the method or the system may exhibit one or more of the following characteristics. The analysis/evaluation may include the calculation of image data of a mapping area of the first and/or the second set of image data (digital zoom). The analysis may include the calculation of image data of mapping areas from the first and/or the second image data of continuously increasing or decreasing in size (continuous digital zoom). The method may include the evaluation of the second image data if the mapping area is located inside the second capturing area. The method may include the evaluation of the first image data if the mapping area is located inside the first capturing area and outside the second capturing area. The method may furthermore include the detection of a color reference in order to obtain color reference data. The analysis may include the calculation of color correction data based on the color reference data. The analysis may include the color correction of image data based on the color correction data. The capturing of the first or the second capturing area may include the capture of the color reference. The color reference may be located in a boundary area of the first capturing area. The first image data may have a first resolution and the second image data may have a second resolution. The first resolution may be smaller than the second resolution. The first capturing device may include the first sensor element and the first imaging element. The second capturing device may include the second sensor element and the second imaging element. The first capturing area may be captured with the first capturing device. The second capturing area may be captured with the second capturing device.

The second capturing device may capture a larger image (a smaller image section) in comparison to the first capturing device. The first and/or the second image data may be selected in a processing unit. The analysis of the first and/or the second image data may take place inside a processing unit. The mapped area may be displayed on an output terminal.

Embodiments of the invention may provide any, all or none of the following benefits. Using two fixed lenses, the system may capture two differently sized capturing areas, e.g. a zoom section and a wide-angle section. Furthermore, two different resolutions may be provided in order to be able to digitally zoom into a large image area with sufficient resolution and without the use of a zoom lens. This may also allow for the color correction of image data of any mapped area being selected.

### BRIEF DESCRIPTION OF THE DRAWINGS

Following is an explanation based on exemplary embodiments with reference to the attached drawings.

FIG. 1 shows a system that may be used for the capture of an image on a material web with a capturing device;

FIG. 2 shows a system that may be used to capture an image with a capturing device and an illuminating element;

FIG. 2A shows a system that may be used to capture an image with a capturing device and two illuminating elements;

FIG. 3 shows an illuminating element with four light-guiding elements and four switching elements;

FIG. 4 shows an illuminating element with two light sources;

FIG. 5 shows a system that may be used to capture an image with two lenses and an illuminating element;

FIG. 6A shows a system that may be used to capture an image with two capturing devices;

FIG. 6B shows a top view of the two capturing areas in the image plane in FIG. 6A, and

FIG. 7 shows a system that may be used to capture an image with two lenses.

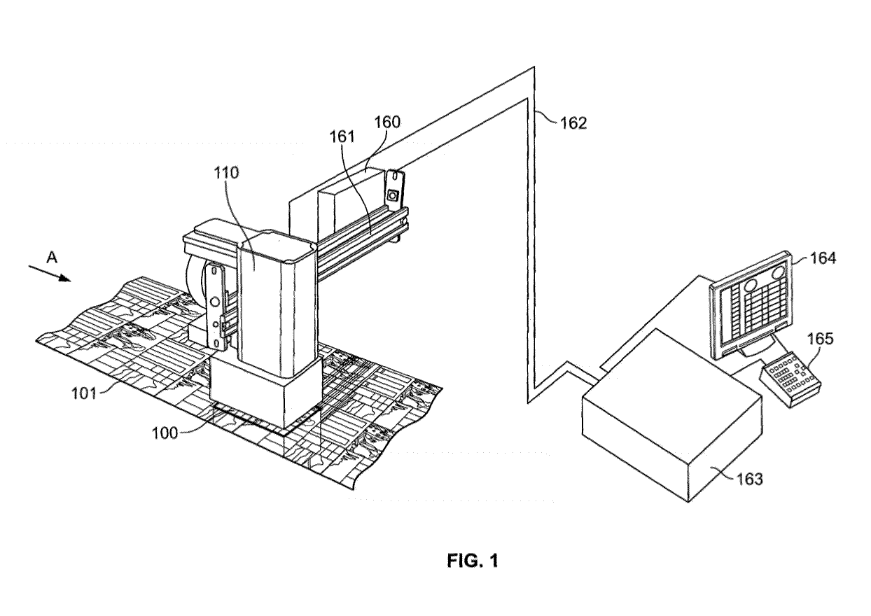

### DETAILED DESCRIPTION

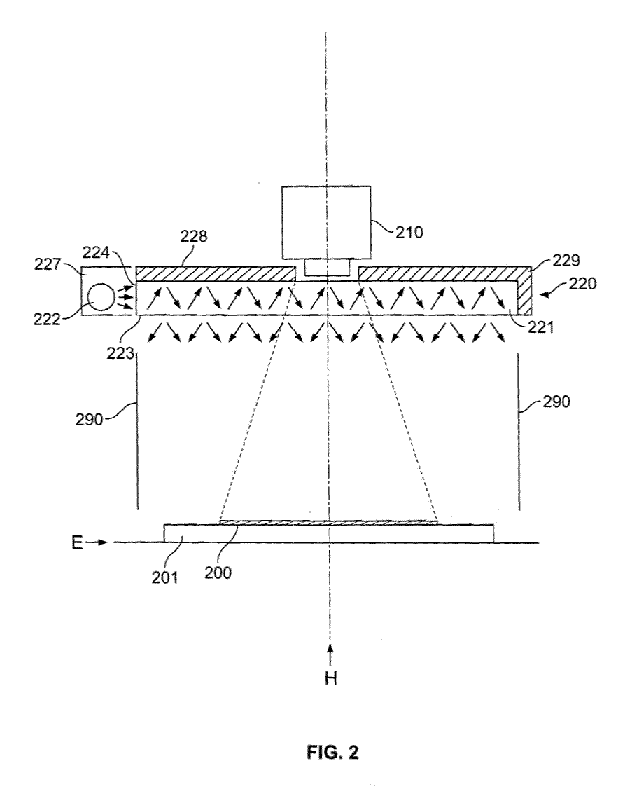

FIG. 2 (not true to scale) shows a system that may be used to capture an image 200 with a capturing device 210 and an illumination element 220. The image may be located on an object like a material web in an object plane E. The image may, however, also be located on pieces of material like paper sheets or printed circuit boards. The image may be, for example, a still picture, a video picture or any other appropriate type of picture. The capturing device is located along a main axis H. The capturing device may be, for example, a CCD or CMOS camera or any other type of capturing device.

In FIG. 2, the illuminating element 220 may be used to create diffuse light and may include a light-guiding element 221 and a light source 222. The light source 222 is configured such that its emitted light is directed into the light-guiding element 221 and propagates in the light-guiding element 221. The light propagating in the light-guiding element 221 then diffusely exits on a surface area 223, or side 223 of the light-guiding element 221 pointing toward the image 200. This may provide even illumination for the capture of the image 200 and may also provide good image quality.

Additional elements may be used to achieve improved (e.g., optimum) lighting, such as the walls 290 in FIG. 2 with a diffuse white surface providing a channel between the illuminating element 220 and the image 200. In this manner, the diffuse light may be ideally directed onto the area that needs to be lit, and the luminous intensity in this area may be increased. Among other things, this may achieve a very good reproduction of holograms or mirrored surfaces.

In FIG. 2, the light-guiding element 221 is a flat plate enclosing the main axis H of the capturing device 210 in the center. The flat plate is located in a plane parallel to an object plane E, which also allows even illumination. By using a plate, the illuminating element may be lightweight and may be built in different sizes. Thus, the system may be supplied in different sizes as well. The light-guiding element may also be configured excentrically around the main axis of the capturing device. The light-guiding element may also be located away from or next to the capturing device, provided this configuration may supply improved (e.g., optimum) illumination for the respective application.

The light is provided by the light source 222 close to the surface areas 224, the side 224, of the plate 221. In order to achieve better light coupling, a reflector 227 may be located around the light source 222. The reflector 227 reflects the light emitted by the light source 222, which is also emitted into other directions in space and which without the presence of the reflector may generally not be directed into the light-guiding element. The reflector 227 may be round in order to achieve improved (e.g., optimum) reflection of the light towards the side 224, for example. If the reflector 227 has a parabolic shape, then the light source 222 may be located closely to the focal point of the parabola. Other appropriate elements for better light coupling in may also be used. The surface areas 224, into which the emitted light is directed, may be smooth, for example, polished or finished in other ways.

The injected light propagates in the light-guiding element 221 (in FIG. 2 indicated by arrows). On the side of the light-guiding element pointing away from the image 200, the propagating light may be, e.g., completely (or near completely) reflected. For this purpose, the light-guiding element may exhibit a mirrored coating or a reflecting layer 228. Other suitable elements for the creation of a reflection may be used as well. On the side of the plate opposite the side 224 a total reflection (or, e.g., near total reflection) may be achieved as well, in this case due to the mirror coating or reflective layer 229. The mirror and the reflective coating may differ in the amount of diffuse light exiting on side 223. If the reflective layer reflects the light diffusely in the light-guiding element 221, more diffuse light can exit on the side 223 than with a mirrored surface. On the other hand, a mirrored surface can be used to achieve a more even distribution of the light through multiple reflection in the light-guiding element 221. In this context is should be understood that a surface area of the light-guiding element may be, e.g., a section of a side as well as the entire side of the light-guiding element.

The light-guiding element in FIG. 2 may therefore be designed such that the propagating light is fully reflected (or near fully reflected) by all surface areas and sides of the light-guiding element 221, for example by a mirror or reflective coating 228, 229, with the exception of the surface areas 224, into which the emitted light is being injected, and the surface areas 223, in which the propagating light exits in a diffused state. In order to facilitate the exit of the propagating light from the surface area 223 in a diffused state the light-guiding element 221 may be made of a material with scattered particles. The material of the light-guiding element itself may be a transparent polymer, such as PMMA. The material may also be glass or a similar material. The scattered particles in the material may be organic and/or inorganic. The refractive index of the scattered particles is different from the refractive index of the light-guiding material. The intensity of the light diffusion is dependent, among other things, from the size of the scattered particles and the difference between the refractive indices of the light-guiding material and the scattered particles. The light-guiding element may also be of another appropriate type like a special optical film or such, for example, to allow the light to exit in a diffused state.

In FIG. 2, the light-guiding element 221 is located between the capturing device 210 and the image 200. The light-guiding element 221 can be made of transparent material, for example, glass or acrylic glass. In such case, the capturing device 210 can capture the image 200 through the light-guiding element 221, as shown in FIG. 2. The illuminating element 220 may be, e.g., mounted directly on the capturing device 210 or on a part supporting the capturing device 210. This may allow for a compact design of the system, and the system may exhibit a small installation depth. The capturing device 210 and the illuminating element 220 may thus form a unit, which may be easy to use. In addition, the system may be used in many ways, e.g., without the development of individual and expensive lighting concepts.

The light-guiding element may also be designed with a cutout in the area, in which the capturing device 210 captures the image 200 (in FIG. 2, this area is indicated by two diagonal dotted lines). In FIG. 2, such cutout is located in the reflective layer 228. As shown, the cutout may be end-to-end or, e.g., in the form of a cavity, such that the cutout may allow the capturing device to capture the image. In that event, the area, in which the capturing device captures the image, may have a thin reflective layer through which the capturing device is able to capture the image. The cutout may also be located directly inside the light-guiding element. This cutout may be located at the center of the light-guiding element, configured around a central point, but may also be located at any other suitable location inside the light-guiding element. In the area, in which the capturing device may capture the image, the light-guiding material is fully transparent or semi-transparent.

In some embodiments, the light-guiding element 221 may generally not be located directly between the capturing device 210 and the image 200 (as shown in FIG. 2) but, as already mentioned, may be positioned in any location suitable for the respective application. As shown in FIG. 2A, an illuminating element 220′ may be located on the side of the image 200 opposite the capturing device 210. As explained in regard to FIG. 2, the illuminating element 220′ of FIG. 2A also exhibits a light-guiding element 221′ and a light source 222′, which may be configured such that the emitted light is directed into the light-guiding element 221′ and propagates in the light-guiding element 221′. Also as described in reference to FIG. 2, the light source 222′ of FIG. 2A may be enclosed by a reflector 227′. This configuration of the side of the image 200 located opposite from the capturing device 210 may be used for the capture of an image on a transparent material web, for example. In this case, the illuminating element 220′ will illuminate the material web 201 from one side, while the capturing device 210 will capture the image from the other side (reverse side lighting). The use of light-colored background metal plates and potential shadows may thus be avoided. This configuration may also provide even illumination.

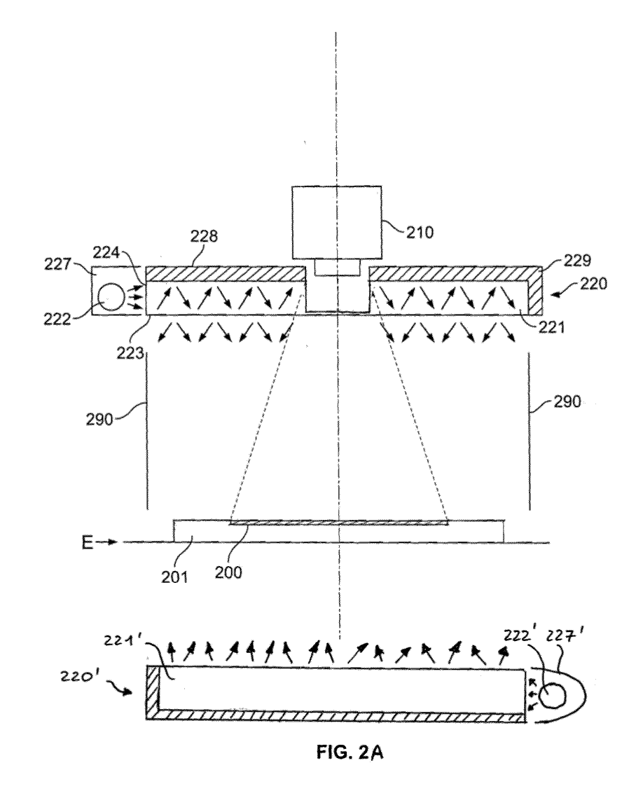

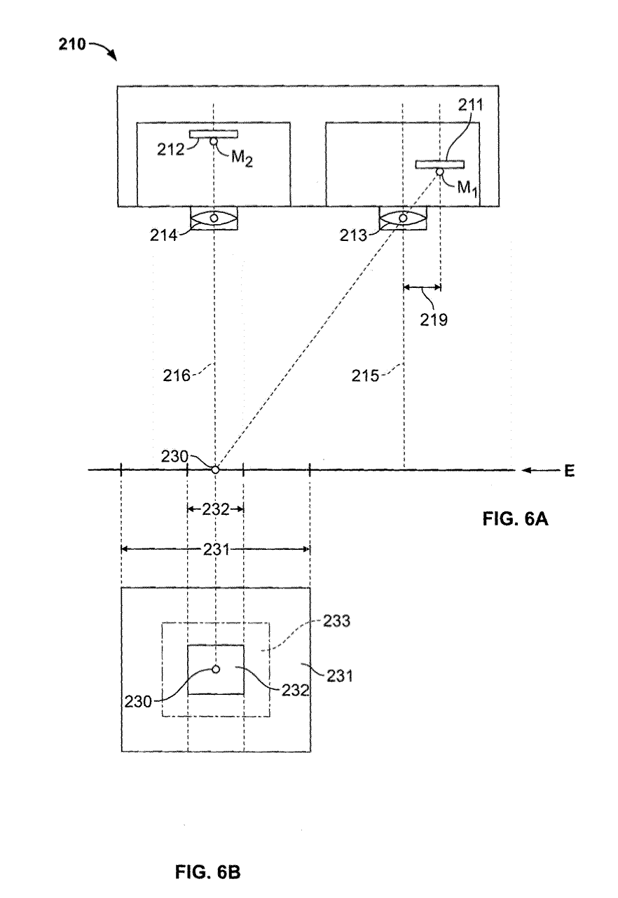

FIG. 3 shows a illuminating element 320 with four light-guiding elements 321 a-d and four switching elements 325a-d. In FIG. 6, the light-guiding elements 321a-d and the switching elements 325a-d are configured in alternate order. The switching elements 325a-d are used for the selective blocking and unblocking of the light propagating in the light-guiding elements 321a-d. The switching elements may be LCDs or any other suitable types of light-switching elements. The light may be injected from a light source 322 at one side of the light-guiding element 321a.

The injected light propagates inside the light-guiding element 321a and in the cases, where the switching element 325d is blocking the light and switching element 325a is letting the light pass, propagates into the light-guiding element 321b. When the switching element 325b lets the light pass through again, the light can propagate into the light-guiding element 321c, and so forth. This may provide the option to selectively illuminate certain areas, as may be important in the capture/detection of textiles, for example. In some embodiments, the illumination may be easily adjusted, e.g., without the development of individual and expensive lighting concepts for each application.

FIG. 3 shows the four light-guiding elements 321 a-d in the shape of triangles. The four triangular light-guiding elements 321 a-d and the four switching elements 325 a-d are configured around a central point 340 and form an enclosed area. At the central point 340 may be a cutout, through which the capturing device is able to capture the image. It should be noted that the illuminating element may include any number of light-guiding elements, for example only 2 or also 8 or more light-guiding elements. For example, two rectangular illuminating elements may be configured next to each other with a switching element in between, or 8 triangular light-guiding elements can be configured in the shape of an octagon, similar to the configuration in FIG. 3. The switching elements can be configured in one plane, but can also be configured in several planes at an angle to each other. For example, in some embodiments, the four light-guiding elements 321 a-d shown in FIG. 3 could be configured to form a pyramid. Any suitable configuration and design of the light-guiding elements and the switching elements is possible.

In some implementations, there may also be multiple light sources injecting light into the light-guiding element. Thus, the degree of illumination may be selected and adjusted. The degree of illumination for the capturing device may be selected to be so high that, e.g., the image may only be captured with sufficient quality at the instant of the flash. This may replace the function of the iris of the capturing device.

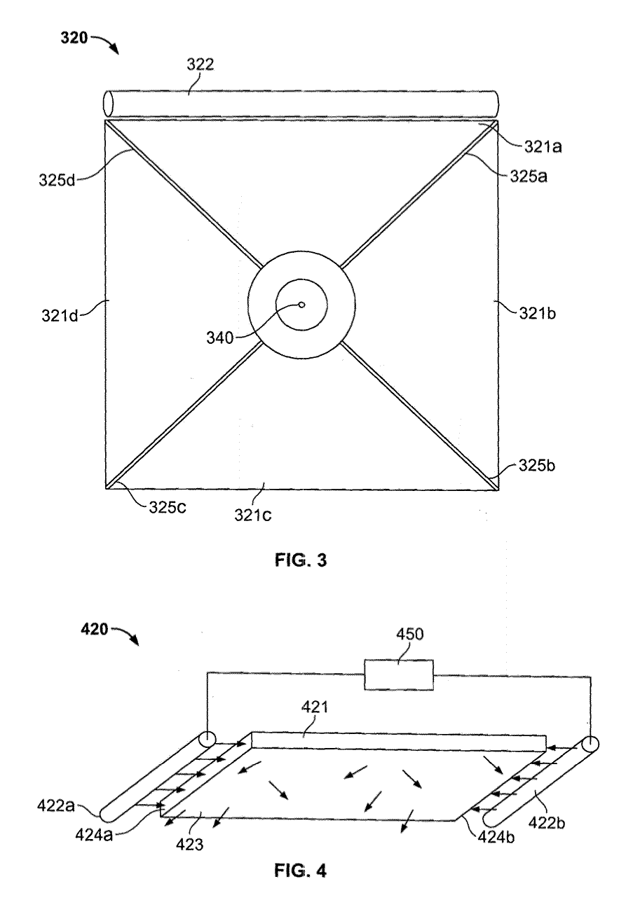

FIG. 4 shows an illuminating element 420 with two light sources, a first light source 422a and a second light source 422b. The first and the second light source 422a and 422b are located on opposite sides 424a and 424b of a light-guiding element 421. On the sides 424a and 424b, the respectively emitted light can be injected into the light-guiding element 421. The light propagates in the light-guiding element 421 and diffusely exits on the side 423 of the light-guiding element 421 (in FIG. 4 suggested by arrows). The first and the second light source 422a and 422b can be light sources of the same type or of different types. If they are of different types, then one of them may be, e.g., a UV light source and the other one a source of white light. These different light sources can be used for different applications. In such case, the system can include a control element 450 for the selective enabling/disabling of the first or the second light source 422a or 422b.

The light source can be gas discharge lamp. For example, the light source may be a flash tube, like a xenon flash tube, for example. The use of any suitable type of light source that may be able to generate a light flash is possible. The duration of the flash may be in the range of a few microseconds, like 1 to 100 μs, for example 10 μs.

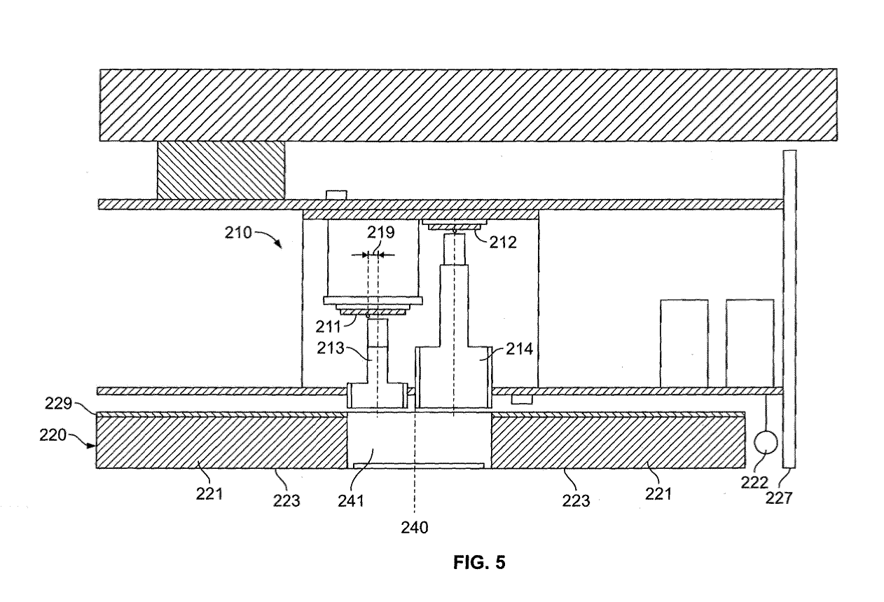

FIG. 5 shows a system 210 for the capture of an image in an image plane (not shown) with two imaging elements or lenses 213 and 214 and an illuminating element 220. At the time of the capture a first capturing area (wide-angle area) is mapped by the first imaging element 213 and detected by the first sensor element 211 and/or a second capturing area (zoom area) is mapped by the second imaging element 214 and detected by the second sensor element 212. The first and/or the second capturing area may be selected automatically and or by a user via a control unit. At the time of capture mentioned above the image may also be exposed to light via the illuminating element 220. The illuminating element 220 shown in FIG. 4 includes a light-guiding element 221 with a end-to-end opening 241 in an area, in which the first lens 213 and the second lens 214 are located. In the following, systems for the capturing of an image in an image plane will be described in greater detail.

FIG. 6A (not true to scale) shows a system 210 for the capturing of an image in an image plane E. The image may be located on a printed material web such as, e.g., paper webs or foil sheets. The image may, however, also be located on pieces of material like paper sheets or printed circuit boards. The system includes a first sensor element 211 and a first imaging element 213 as well as a second sensor element 212 and a second imaging element 214. The first sensor element 211 and the second sensor element 212 are each configured inside a plane parallel to the image plane E. The first imaging element 213 and the second imaging element 214 respectively is located between the image plane E and the first sensor element 211 and the second sensor element 212 respectively. The system may capture a first capturing area 231 and a second capturing area 232 in the image plane E. In FIG. 6A, the second capturing area 232 (zoom area) is smaller than the first capturing area 231 (wide-angle area).

FIG. 6B shows a top view of the capturing area indicated in FIG. 6A in the image plane E (viewed from the system 210 shown in FIG. 2A). In FIG. 6B, the second capturing area 232 includes a section of the first capturing area 231 and is located inside the first capturing area 231. The center of the first capturing area 231 and the center of the second capturing area 232 fall together into a central point 230, i.e., the second capturing area 232 is located in the center of the first capturing area, around a central point 230. It should be understood that any other positioning of the second capturing area partially or completely inside the first capturing area is possible as well, such as, for example, inside a boundary area of the first capturing area. The image in the image plane can be detected using a CMOS chip, e.g. a CMOS matrix chip, as a first and/or second sensor element. It should be understood, that detection may be carried out with any other appropriate type of sensor element like a CCD chip.

In the system shown in FIG. 6A, the first imaging element 213 includes a first optical axis 215, indicated by a perpendicular dotted line, and which passes through the center of the imaging element 213. Similarly, the second imaging element 212 includes a second optical axis 216. In FIG. 6A, the first optical axis 215 and the second optical axis 216 are parallel to each other. The first and/or the second imaging element may, e.g., include one or more lens components. An imaging element can also be understood to be a system of lens components or a camera lens, for example. The first and second imaging elements 213 and 214 shown in FIGS. 6A and 6B are both fixed lenses. As an example, a 20 mm lens could be used as a first imaging element and an 8 mm lens could be used as a second imaging element. However, it should be understood that the choice of imaging element may be dependent on the respective application.

In FIG. 6A, the first sensor element 211 is configured such that the center M1 of the sensor element 211 is offset 219 in relation to the first optical axis 215. The offset 219 in FIG. 6a is indicated as the distance between the first optical axis 215 passing through the center of the first imaging element 213 and the perpendicular dotted line passing through the center point M1. The center point M1 of the first sensor element 211 is located on a line passing through the center 230 of the first capturing area 231 and the center of the first imaging element 213. Therefore, it is possible to capture two differently sized capturing areas—a zoom area and a wide-angle area, for example—using two fixed lenses (objectives). The position and thus the offset of the first sensor element 211 can be calculated with the intercept theorems. The degree of the offset depends on the respective design of the system (e.g. the distance to the image plane E). Purely as an example, the offset could be less than 1 mm, e.g. 0.7 mm.

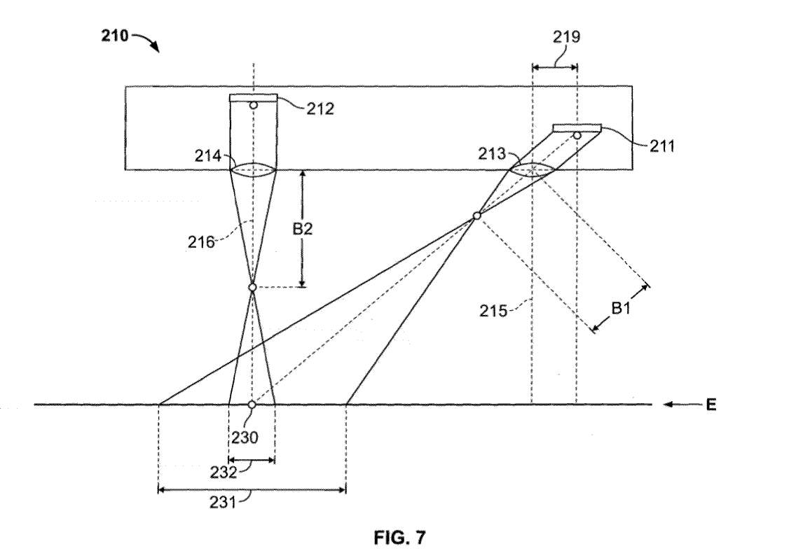

As shown in FIG. 7, the first imaging element 213 and the second imaging element 214 have different focal lengths. The first imaging element has a focal length B1 and the second imaging element 214 has a focal length B2. The focal length of the first imaging element 213 is shorter than the focal length of the second imaging element 214, i.e. the focal length B1 is smaller than the focal length B2. The first sensor element 211 and the first imaging element 213 with the shorter focal length B1 are configured such that the first capturing area 231 (the wide-angle area shown in FIGS. 6A and 6B) is mapped by the first imaging element 213 and detected by the first sensor element 211. In an analogous manner, the second sensor element 212 and the second imaging element 214 are configured such that the second capturing area 232 (the zoom area as shown in FIGS. 6A and 6B) is mapped by the second imaging element 214 and detected by the second sensor element 212. In FIG. 7, the second sensor element 212 detects a larger image compared to the first sensor element 211, i.e. the second sensor element 212 detects a smaller image section (zoom) than the first sensor element 211. As mentioned earlier, the first sensor element 211 and the second sensor element 212 are each located in a plane parallel to the image plane E. As indicated, in some embodiments, these planes may be two different planes. Due to their different focal lengths B1 and B2, the two capturing devices are located in different planes. In some embodiments, depending on the respective design, the two planes may also form the same plane.

In an implementation, the second sensor element 212 may be centered in relation to the second optical axis 216, as shown in FIGS. 6A, 6B and FIG. 7. The center M2 of the second sensor element 212 is positioned on the optical axis 216 of the second capturing device.

In another implementation, the second sensor element may exhibit an offset to the optical axis in the same manner as described above in reference to the first sensor element. In such case the second sensor element is configured such that the center of the second sensor element exhibits an offset in relation to the second optical axis. The second sensor element is therefore configured such that the center of the second sensor element is located on a line passing through the center of the second capturing area and the center of the second imaging element.

It should be understood that more than one second sensor element and more than one second imaging element may be used to capture more than one second capturing area. For example, a total of three sensor elements and three imaging elements may be used to capture one of three capturing areas respectively. The third capturing area may then be located inside the second capturing area, and the second capturing area inside the first capturing area. This allows for several zoom areas.

It should be understood that the configuration described above is interchangeable for the first and the second capturing devices. The first sensor element may be centered in relation to the first optical axis, and the second sensor element may be offset in relation to the second optical axis. Both sensor elements, as described above, may also be offset from the respective optical axis. The second capturing area may also be mapped by the first imaging element and detected by the first sensor element, and accordingly the first capturing area may be mapped by the second imaging element and detected by the second sensor element.

In conjunction with a system for the capturing of an image, the further processing of the obtained images is of interest as well (image processing). We will now describe a method for the analysis of image data in reference to FIGS. 6A and 6B. This method can be applied in connection with the system described above. The method may include the following steps:
Provision of a first capturing device and at least one second capturing device for the capture of an image in the image plane E;
Capture of the first capturing area 231 in order to obtain first image data,
Capture of a second capturing area 232 in order to obtain second image data, and
Analysis of the first and/or the second image data.

As shown in FIG. 6A, the first capturing device includes the first sensor element 211 and the first imaging element 213. Accordingly, the second capturing device includes the second sensor element 212 and the second imaging element 214. The capture of the first capturing area 231 is performed with the first capturing device, and the capture of the second capturing area 232 is performed with the second capturing device. In FIGS. 6A and 6B, the second capturing area 232 is located inside of the first capturing area 231. Compared to the first sensor element 211, the second sensor element 212 captures an enlarged image (a smaller image section). Provided the first image data have a first resolution and the second image data have a second resolution, then the first resolution is smaller than the second resolution. Accordingly, two different resolutions are provided, which may be used for the processing of the image. For example, the resolution of the image data can be indicated as the number of picture elements in relation to a physical unit of length, such as in dpi (dots per inch), or ppi (pixel per inch). The first and the second image data may be stored together in a memory unit.

In an implementation, the evaluation/analysis and calculation of image data of a mapping area 233 shown in FIG. 6B from the first and/or the second image data (digital zoom) may also be included. The first and/or the second image data may be selected in a processing unit, which may, for example, read the image data from the memory unit. The data may be selected automatically or by a user. If the image data are selected automatically, the selection may take place as follows. If the mapping area 233 is located inside the second capturing area 232 (not shown in FIG. 6B), then the second set of image data will be analyzed in order to calculate the image data of mapping area 233. But if the mapping area 233 is located inside the first capturing area 231 and outside the second capturing area 232 (as shown in FIG. 6B by a semi-dotted line), the first set of image data will be analyzed in order to calculate the image data of mapping area 233. Accordingly, in some embodiments, the zoom is not an optical zoom such as with a zoom lens but rather a digital zoom. The presence of two different resolutions may provide digital zooming capability at a sufficiently high resolution in a large image area, without the use of a zoom lens.

The analysis and calculation of image data of mapping area 233 from the first and/or the second image data may be performed in a processing unit. The image data of the area of interest 233 may be determined with the usual methods of image processing. They can, for example, be calculated by interpolation between the individual pixel values of the first and/or the second image data. The area of interest can then be sent to an output terminal, like a monitor, for example. Also possible is an image-in-image function, where the output terminal displays in a large window a mapping area calculated from the first image data, and in a smaller window a mapping area calculated from the second image data or vice versa.

Mapping area 233 may be predefined or may be freely selected by the user. Continuously increasing (zoom out) or decreasing (zoom in) mapping areas 233 may also be used, and their image data may be successively calculated from the first and/or the second image data (continuous digital zoom). For cases in which the mapping areas are continuously decreasing, the analysis of the first image data with low resolution may be switched to the analysis of the second data with a higher resolution as soon as mapping area 233 becomes part of the second capturing area. This may allow continuous digital zooming inside a large image area without time delay and a sufficiently high resolution.

It may happen that the captured image data do not reflect the true colors since the RGB (red-green-blue) components may shift when the illumination changes, for example. In another embodiment, the method may therefore include the capability to detect a color reference, like a color reference strip, in order to obtain color reference data (color calibration). The capture of the color reference can be part of the capture of the first or of the second capturing area. For this purpose, the color reference may be located inside a boundary area of the first capturing area 231 shown in FIG. 6B. The color reference can, for example, be located in the first capturing device (see FIG. 6A) and be mapped onto a boundary area of the first capturing area 231. In the analysis process, the color correction data may be determined based on the color reference data, for example, by comparing the color reference data with the image data. If a deviation of the image data from the color reference data is detected, the color of the images may be corrected accordingly for any selected mapping area. With a zoom lens this may generally not be possible since, if the color reference is located inside a boundary area, this color reference would not be detected for every selected mapping area. By using two capturing devices, including fixed lenses, a color correction can be provided for each selected mapping area, as described above.

It should, of course, be understood that the systems described above can be operated with the methods described above, just as the methods described above can be applied to the systems described above.

What is claimed is:

1. A system, comprising:
a device configured to capture an image; and
an illumination element configured to generate diffuse light, the illumination element comprising:
a light-guide element; and
at least one light source arranged relative to the light-guide element such that emitted light from the at least one light source is injected into and propagates in the light-guide element; and
wherein the light-guide element is configured such that the emitted light propagating in the light-guide element exits the light-guide element as the diffuse light at least one surface area of the light-guide element.

2. The system of claim 1, wherein the light-guide element comprises a flat plate.

3. The system of claim 2, wherein the light-guide element is configured such that the flat plate is located in a plane parallel to an object plane, the image being in or parallel to the object plane.

4. The system of claim 1, wherein at least one other surface area of the light-guide element is coated with at least one of a mirroring coating or a reflective coating.

5. The system of claim 1, wherein the at least one other surface area of the light-guide element comprises all surface areas of the light-guide element other than any surface areas of the light-guide element at which the emitted light is injected into the light-guide element or at which emitted light exits out of the light-guide element.

6. The system of claim 1, wherein the light-guide element is configured such that the emitted light is injected into the light-guide element at least one second surface area, and
wherein the at least one second surface area is smooth.

7. The system of claim 6, wherein the at least one second surface area is polished.

8. The system of claim 1, wherein the light-guide element comprises a material, the material having scattered particles.

9. The system of claim 1, wherein the scattered particles cause the emitted light to exit the light-guide element in a diffuse state as the diffuse light.

10. The system of claim 1, wherein the light-guide element comprises a transparent material.

11. The system of claim 1, wherein the transparent material comprises acrylic glass.

12. The system of claim 1, wherein the light-guide element is configured such that the device is capable of capturing the image through the light-guide element.

13. The system of claim 1, wherein the light-guide element is configured to have a cutout portion, the cutout portion being located in an area in which the device is capable of capturing the image.

14. The system of claim 1, wherein the light-guide element is located between the device and the image.

15. The system of claim 1, wherein the image is located between the device and the light-guide element.

16. The system of claim 1, wherein the illumination element further comprises:
at least one other light-guide element; and
at least one switching element configured to selectively block or let pass the emitted light.

17. The system of claim 16, wherein the at least one switching element is configured to selectively block or let pass the emitted light from the light-guide element to the at least one other light-guide element.

18. The system of claim 16, wherein the at least one other light-guide element and the at least one switching element are disposed alternating to each other in a plane of the illumination element.

19. The system of claim 16, wherein illumination element is configured such that the light-guide element and the at least one other light-guide element have a triangular shape.

20. The system of claim 16, wherein the light-guide element, the at least one other light-guide element, and the at least one switching element are disposed around a central point of the illumination element, forming a closed area.

21. The system of claim 1, wherein the at least one light source comprises a first light source and a second light source.

22. The system of claim 21, wherein the first light source is disposed on a first side of the light-guide element and the second light source is disposed on a second side of the light-guide element opposite to the first side, such that the first and second light sources are located opposite to one another.

23. The system of claim 21, wherein the first light source is a different type of light source than the second light source.

24. The system of claim 21, further comprising:
a control element configured to selectively switch on and off at least one of the first light source or the second light source.

25. The system of claim 1, wherein the image is located on a material web.

26. The system of claim 1, wherein the at least one light source comprises a gas-discharge lamp.

27. The system of claim 26, wherein the gas discharge lamp comprises a flash tube.

28. The system of claim 1, wherein the device is located along a main axis.

29. The system of claim 1, wherein the device comprises:
at least one sensor element.

30. The system of claim 1, wherein the device comprises:
at least one sensor element; and
at least one imaging element.

31. A method, comprising:
capturing an image in an object plane using a system, the system comprising:
a device configured to capture the image; and
an illumination element, the illumination element comprising:
a light-guide element; and
at least one light source arranged relative to the light-guide element such that emitted light from the at least one light source is injected into and propagates in the light-guide element; and
wherein the light-guide element is configured such that the emitted light propagating in the light-guide element exits the light-guide element at least one surface area of the light-guide element in a diffuse state.

32. The method of claim 31, wherein at least one other surface area of the light-guide element is coated with at least one of a mirroring coating or a reflective coating.

33. The system of claim 31, wherein the light-guide element comprises a material, the material having scattered particles.

34. A system, comprising:
a device configured to capture an image, the image being in an object plane; and
an illumination element configured to generate diffuse light, the illumination element comprising:
a light-guide element comprising a material, the material having scattered particles; and
at least one light source configured to generate a light flash arranged relative to the light-guide element such that emitted light from the at least one light source is injected into and propagates in the light-guide element; and
wherein the light-guide element is configured such that the emitted light propagating in the light-guide element exits the light-guide element as the diffuse light at least one surface area of the light-guide element; and
wherein at least one surface area of the light-guide element has at least one of a mirroring layer or a reflective layer.

35. The system of claim 34, wherein the scattered particles cause the emitted light to exit the light-guide element in a diffuse state as the diffuse light.

36. The system of claim 34, wherein the mirroring or reflective layer is on a first side of the light-guide element that opposes a second side of the light-guide element, the second side of the light-guide element facing the image.
